(19) United States
(12) Patent Application Publication
(10) Pub. No.: US 2025/0145074 A1
(43) Pub. Date: May 8, 2025

(54) MATERIAL DELIVERY VEHICLE

(71) Applicant: Jeffrey D. Chesser, Marietta, GA (US)

(72) Inventor: Jeffrey D. Chesser, Marietta, GA (US)

(21) Appl. No.: 18/387,652

(22) Filed: Nov. 7, 2023

(51) Int. Cl. B60P 3/14

(52) U.S. Cl. CPC B60P 3/14

(57) ABSTRACT

A material delivery vehicle includes a chassis, rear wheels, front wheels, and a passenger cab. The vehicle also includes a material bed, a delivery belt system, and an equipment bed. A walking floor type conveyor is positioned over the floor that moves material within the material bed to a position located at the rear of the material bed. The delivery belt system is mounted directly behind the material bed so that material being moved off the conveyor belt falls directly onto the delivery belt system. The delivery belt system has a conveyor belt with a delivery end. The material bed and equipment bed extend beyond the delivery belt system so as to form a notch adjacent the delivery belt system. The delivery end of the conveyor belt is similarly positioned above or closely adjacent the frame rail associated with the delivery side.

### CROSS REFERENCE TO RELATED APPLICATIONS

Not applicable.

### STATEMENT REGARDING FEDERALLY SPONSORED RESEARCH OR DEVELOPMENT

Not applicable.

### The Names of the Parties to a Joint Research Agreement

Not applicable.

### FIELD OF THE INVENTION

The invention relates generally to a vehicle for simultaneously delivering top-dressing material, mulch, loose aggregate, and the equipment, tools or machinery necessary to install the material thereby eliminating the necessity to use multiple vehicles or multiple trips.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Today, loose material such as top-dressing gravel, sand, dirt, mulch, and the like are delivered in large trucks. The material is placed in a rear positioned bed where the material may be either pushed out of the rear of the bed or the bed is tilted to gravitationally dump the material from the bed. This type of delivery results in a large pile being produced on the ground adjacent the truck. As such, the material must still be loaded onto wheelbarrows or moved with small front end loaders to move the material to the desired final location.

Trucks have also been designed to specifically deliver top-dressing material such as mulch or other loose material to a jobsite. These trucks include a material bed that contains the loose material and a material movable tarp that moves the material to the rear of the bed. These trucks also have an endless loop conveyor belt positioned adjacent the rear of the bed so that the material being moved to the rear of the bed is dumped onto the conveyor belt. The conveyor belt then moves the material laterally with respect to the truck so that it may be dumped into a wheelbarrow or other transport vehicle to the side of the truck. A problem with this is that the wheelbarrow must be positioned to the side of the truck to catch the material being dumped off the conveyor belt, which can be a problem when the truck is parked on a road used by other passing vehicles. Another problem with these trucks is that the location of the conveyor belt system adds additional weight at the very rear end of the truck, which may cause the truck's weight or center of gravity to shift rearward to an undesired degree.

The background of this invention comes from the observation of existing practices, methods and equipment previously and currently used throughout the topdressing industry. Such observations have led to the desire for a more efficient and economical way to delivery, install and apply top-dressing material and general landscape supply materials to the residential and commercial sector. This novel and improved concept centers around the invention of a vehicle/truck body with a forward material hopper capable of holding, storing and delivering material mechanically into a mid-mount side dispensing apparatus and a rear ‘dove tail” type machinery platform capable of efficiently loading and offloading machinery for transporting and installing dispensed material from forward mount hopper.

Accordingly, it is seen that a need remains for a singular material and equipment delivery truck which provides an efficient manner of delivering material and necessary installation equipment in a quick yet safe manner. It is to the provision of such therefore that the present invention is primarily directed.

### BRIEF SUMMARY OF THE INVENTION

In a preferred form of the invention, a material delivery vehicle comprises a chassis, a cab mounted to the chassis, a material bed mounted to the chassis directly behind the cab, an equipment bed mounted to the chassis, and a delivery belt system mounted to the chassis between the material bed and the equipment bed.

In another preferred form of the invention, a material delivery vehicle comprises a chassis, a cab mounted to the chassis, a material bed mounted to the chassis directly behind the cab, an equipment bed mounted to the chassis, and a delivery belt system mounted to the chassis, wherein the material bed has a sidewall positioned a first select distance laterally from the chassis, wherein the equipment bed has a sidewall positioned a second select distance laterally from the chassis, and wherein the delivery belt system has a sidewall positioned a third select distance laterally from the chassis, and wherein the third select distance is less than the first select distance and less than the second select distance.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1 is a perspective view of a material delivery vehicle embodying principles of the invention in a preferred form.

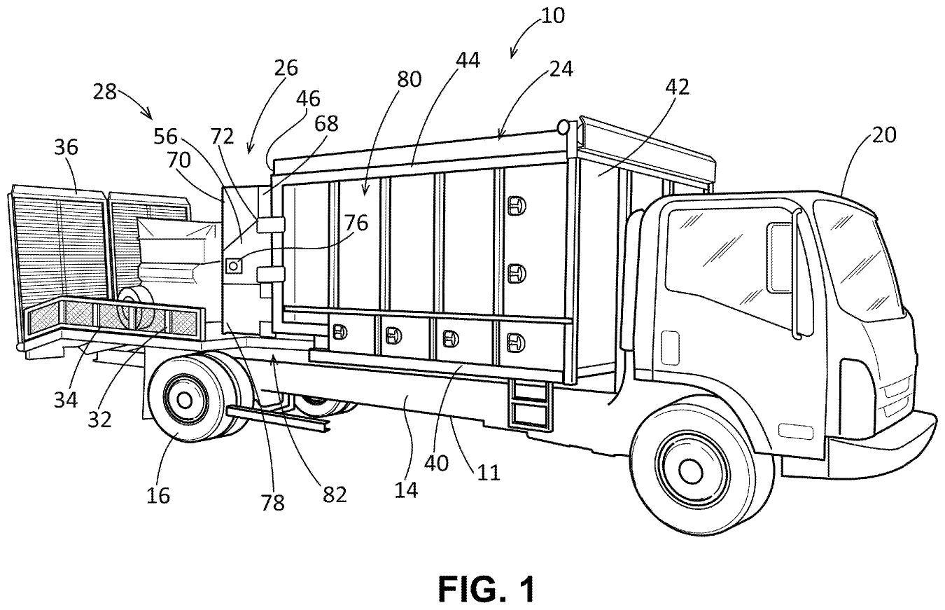

FIG. 2 is a schematic side view of the material delivery vehicle of FIG. 1.

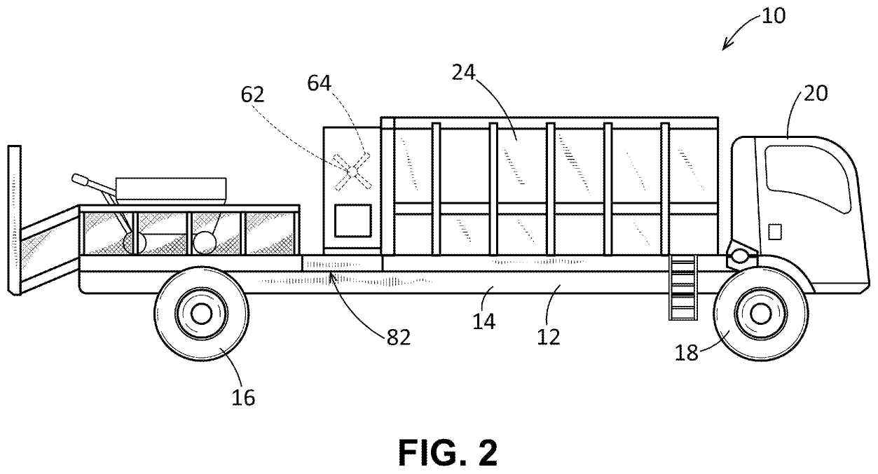

FIG. 3 is a schematic top view of the material delivery vehicle of FIG. 1.

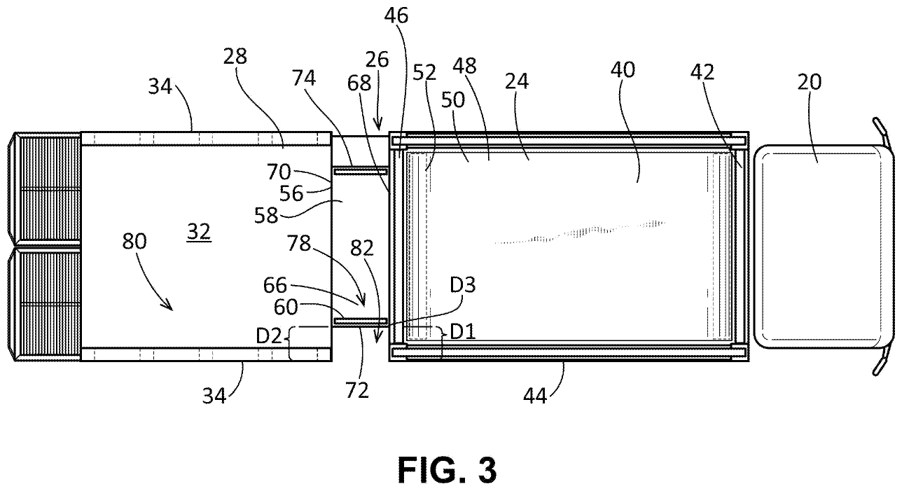

### DETAILED DESCRIPTION OF CERTAIN EMBODIMENTS

With reference next to the drawings, there is shown a top-dressing material delivery vehicle 10 according to the present invention in the form of a truck, referenced hereinafter simply as vehicle 10. The vehicle could also be in the form of a trailer.

The vehicle 10 includes a frame or chassis 12 having longitudinal rails or beams 14. The vehicle 10 also includes the typical additional components of a truck, such as rear wheels and suspension 16, a front wheels and suspension 18, unshown rear axle, unshown drivetrain of a motor and transmission, and a passenger cab 20 positioned at the front end of the frame 12. A trailer embodiment would not include the cab or drivetrain of a truck.

The vehicle 10 also includes a material bin or bed 24 mounted to a forward end of the frame 12 directly behind or rearward of the cab 20, a delivery belt system 26 is mounted directly behind or rearward of the material bed 24 and in front of the rear wheels 16, and an equipment bed 28 is mounted directly behind or rearward of the delivery belt system 26. The delivery belt system 26 may be a belted, tarped, or walking floor system that is coupled to the material bed 24 so as to be capable of moving material to the rear and side of the material bed 24. The forward end represents the front end of the vehicle and its components relative to the vehicle's customary forward direction, while the rearward end is the trailing end opposite from the forward end.

The cab 20 includes all the conventional components such as seats, dashboard, gauges, steering wheel, transmission shifter, etc. The cab 20 is typically positioned over the motor and transmission of the vehicle 10.

The equipment bed 28 includes a floor 32, side walls or rails 34 extending upwardly from the floor 32, and a rear tilting tailgate or ramp 36. The tailgate 36 pivots rearwardly so that equipment may be run up and down the ramp and onto the floor 32 through a position behind the vehicle 10. This positioning eliminates the dangers associated with having a side tilting ramp that encroaches onto pathway of the road. The equipment bed 28 is used to store and transport equipment associated with the loading or distribution of material, such as wheelbarrows, small tractors, lawnmowers, or other construction related equipment.

The material bed 24 is generally an open top container having a floor 40, a front wall 42, two oppositely disposed sidewalls 44, and a rear wall 46. The front wall 42, sidewalls 44, and rear wall 46 all extend upwardly from the floor 40. A walking floor type conveyor 48 is positioned over the floor 40 that moves loose material within the material bed 24 to a position located at the rear of the material bed 24. The conveyor 48 may also be a movable or rollable tarp type system of other moving floor system that moves large amounts of material contained within the material bed 24.

The conveyor 48 includes an endless loop conveyor belt 50 that is rotated through hydraulic or electric motorized rollers 52. The conveyor belt 50 may be a chevron patterned conveyor belt that is specifically designed for moving loose material.

The delivery belt system 26 is mounted directly behind the material bed 24 so that material being moved off the conveyor belt 50 falls directly onto the lower and adjacent delivery belt system 26. The delivery belt system 26 is a self-contained unit having a housing 56, an endless loop conveyor belt 58, a hydraulic or electric motorized roller 60 for rotating the conveyor belt 58, and a hydraulic or electrical motor driven mulch mixing auger 62 having tines or arms 64 positioned to expand or fluff mulch material being dumped upon the conveyor belt 58, although materials other than mulch may also be processed. The housing 56 includes a floor 66, a front wall 68, a rear wall 70, a first sidewall 72, and a second sidewall 74. The controllers 86 for the operation on the conveyor 58 may be placed on the first sidewall 72 for convenience and accessibility. The conveyor belt 58 has an exit or delivery end 78 located at the last, outermost, or outside roller 60 wherein material is expelled or dumped off the conveyor belt 58. The side of the vehicle 10 associated with the delivery end 78 is referenced herein as the delivery side 80 of the vehicle 10.

To maximize volume or sizing, the material bed 24 has its sidewall 44 on the delivery side 80 positioned to extend well outside the frame rail 14 associated with the delivery side 80. Similarly, the equipment bed 28 has its sidewall or side rail 34 positioned to extend well outside the frame rail 14 associated with the delivery side 80. However, the delivery belt system 26 has its first sidewall 72 positioned above or closely adjacent the frame rail 14 associated with the delivery side 80. The delivery end 78 of the conveyor belt 58 is similarly positioned above or closely adjacent the frame rail 14 associated with the delivery side 80. As such, it should be understood that the delivery end 78 of the conveyor belt 58 and the first sidewall 72 of the delivery belt system housing 56 associated with the delivery side 80 are positioned inboard of the adjacent sidewalls 44 and 34 of the material bed 24 and equipment bed 28, thus forming a delivery notch, notch area, or recess 82 along the delivery side 80 of the vehicle 10 to allow access to the material being expelled from the conveyor belt 58 while minimizing the encroachment of the wheelbarrow or other collection device in the roadway.

Thus, the material bed 24 has its delivery side sidewall 44 positioned a first select distance D1 laterally from the chassis 12. The equipment bed has its delivery side sidewall 34 positioned a second select distance D2 laterally from the chassis. The delivery belt system has its delivery side first sidewall 72 positioned a third select distance D3 laterally from the chassis (generally at or nearly even with the chassis). As such, the third select distance D3 is less than said first select distance D1 and less than said second select distance D2 to form the notch area 82.

In use, loose material, such as mulch or other top-dressing materials, is deposited into the material bed 24 through the open top of the material bed 24 and onto the conveyor belt 50 of conveyor 48 within the material bed 24. The vehicle 10 is then driven to the job site for the material to be delivered. Once at the job site, a wheelbarrow or other transportation device, is positioned within the notch area 82 of the delivery side 80 of the vehicle 10. The notch area 82 allows the wheelbarrow to be positioned closer to the delivery end 78 of conveyor belt 58, to minimize waste from spillage while also minimizing the encroachment of wheelbarrows and the like into the roadway.

The controller 76 is then actuated so as to selectively activate the material bed conveyor 48, the auger 62, and the conveyor belt 58 of the delivery belt system 26. The movement of the material bed conveyor 48 causes the loose material to be moved rearwardly until it falls off the conveyor 48 and through the arms 64 of the auger 62. The movement of the auger 62 causes the material to be expanded or fluffed up to maximize the volume of the loose material. The loose material falls through the auger 62 and onto the underlying conveyor 58 of the delivery belt system 26.

The delivery belt system 26 is then activated, either sequentially with or simultaneously with the activation of the conveyor 48, so that the loose material is expelled off the exit or delivery end 78 of the conveyor belt 50 and onto the underlying wheelbarrow or other equipment.

It should be understood that the positioning of the delivery belt system 26 between the material bed 24 and the equipment bed 28 places the delivery belt system 26 forward of the rear wheels 16. This placement allows the weight of the delivery belt system 26 to be more centralized for better balancing of the vehicle's weight or center of gravity. The is different from prior art vehicles that have a delivery belt system 26 mounted at the extreme rear end of the vehicle, which causes the vehicle to be tail heavy.

It thus is seen that a material delivery vehicle is now provided which overcomes problems associated with the prior art. While this invention has been described in detail with particular references to the preferred embodiments thereof, it should be understood that many modifications, additions and deletions, in addition to those expressly recited, may be made thereto without departure from the spirit and scope of the invention as set forth in the following claims.

1. A top-dressing material delivery vehicle comprising:
a chassis;
a pair of rear wheels;
a pair of front wheels;
a cab mounted to said chassis;
a material bed mounted to said chassis directly behind said cab;
an equipment bed mounted to a rear end of said chassis, and
a delivery belt system mounted to said chassis between said material bed and said equipment bed.

2. The top-dressing material delivery vehicle of claim 1 wherein said delivery belt system forms a side notch area relative to said material bed and said equipment bed.

3. The top-dressing material delivery vehicle of claim 1 wherein said material bed has a sidewall positioned a first select distance laterally from said chassis, wherein said equipment bed has a sidewall positioned a second select distance laterally from said chassis, and wherein said delivery belt system has a sidewall positioned a third select distance laterally from said chassis, and wherein said third select distance is less than said first select distance and less than said second select distance.

4. The top-dressing material delivery vehicle of claim 1 wherein said equipment bed has a rear tailgate ramp.

5. The top-dressing material delivery vehicle of claim 1 wherein said delivery belt system is mounted forwardly of said rear tires.

6. A top-dressing material delivery vehicle comprising:
a chassis having a forward end and a rear end;
a pair of rear tires;
a pair of front tires;
a material bed mounted to said forward end of said chassis;
an equipment bed mounted to said rear end of said, and
a delivery belt system mounted to said chassis between said material bed and said equipment bed, said delivery belt system also being mounted to said chassis in a position between said pair of rear tires and said pair of front tires.

7. The top-dressing material delivery vehicle of claim 6 wherein said delivery belt system forms a side notch area relative to said material bed and said equipment bed.

8. The top-dressing material delivery vehicle of claim 6 wherein said material bed has a sidewall positioned a first select distance laterally from said chassis, wherein said equipment bed has a sidewall positioned a second select distance laterally from said chassis, and wherein said delivery belt system has a sidewall positioned a third select distance laterally from said chassis, and wherein said third select distance is less than said first select distance and less than said second select distance.

9. The top-dressing material delivery vehicle of claim 6 wherein said equipment bed has a rear tailgate ramp.

10. The top-dressing material delivery vehicle of claim 6 further comprising a cab mounted to said chassis.

11. A top-dressing material delivery vehicle comprising:
a chassis;
a pair of rear wheels;
a pair of front wheels;
a cab mounted to said chassis;
a material bed mounted to a front portion of said chassis directly behind said cab;
an equipment bed mounted to a rear portion of said chassis, and
a delivery belt system mounted to said chassis,
wherein said material bed has a sidewall positioned a first select distance laterally from said chassis, wherein said equipment bed has a sidewall positioned a second select distance laterally from said chassis, and wherein said delivery belt system has a sidewall positioned a third select distance laterally from said chassis, and wherein said third select distance is less than said first select distance and less than said second select distance.

12. The top-dressing material delivery vehicle of claim 11 wherein said delivery belt system is mounted to said chassis in a position between said material bed and said equipment bed.

13. The top-dressing material delivery vehicle of claim 11 wherein said equipment bed has a rear tailgate ramp.

14. The top-dressing material delivery vehicle of claim 11 wherein said delivery belt system is positioned forwardly of said rear wheels.

15. A top-dressing material delivery vehicle comprising:
a chassis;
a material bed mounted to a forward end of said chassis directly behind said cab;
an equipment bed mounted to a rearward end of said chassis, and
a delivery belt system mounted to said chassis, said delivery belt system having a conveyor belt having an exit end,
wherein said material bed has a sidewall positioned a first select distance laterally from said chassis, wherein said equipment bed has a sidewall positioned a second select distance laterally from said chassis, and wherein said delivery belt system said exit end of said conveyor belt positioned a third select distance laterally from said chassis, and wherein said third select distance is less than said first select distance and less than said second select distance.

16. The top-dressing material delivery vehicle of claim 15 wherein said delivery belt system is mounted to said chassis in a position between said material bed and said equipment bed.

17. The top-dressing material delivery vehicle of claim 15 wherein said equipment bed has a rear tailgate ramp.

18. The top-dressing material delivery vehicle of claim 15 further comprising a cab mounted to said chassis.
